(19) United States
(12) Patent Application Publication
(10) Pub. No.: US 2015/0193377 A1
(43) Pub. Date: Jul. 9, 2015

(54) Sensitivity Analysis of an Independent Variable Based on Regression

(71) Applicant: Bank of America Corporation, Charlotte, NC (US)

(72) Inventors: Kasilingam Basker Laxmanan, Newark, DE (US); Yudong Chen, Greenwood Village, CO (US); Hemei Liu, Wilmington, DE (US); Peng Song, Newark, DE (US); Ramesh Murthy, Chandler, AZ (US); Hanli Huang, Newark, DE (US)

(73) Assignee: Bank of America Corporation, Charlotte, NC (US)

(21) Appl. No.: 14/149,964

(22) Filed: Jan. 8, 2014

(51) Int. Cl. G06F 17/18

(52) U.S. Cl. CPC G06F 17/18

(57) ABSTRACT

According to one embodiment, a system includes one or more processors operable to determine an equation that provides a relationship between a dependent variable of the equation and a plurality of independent variables of the equation, and determine a predicted dependent variable based on the equation. The processors are further operable to, for one or more of the independent variables, perform a regression based on the predicted dependent variable. The processors are further operable to, for each of the one or more independent variables, determine a level of sensitivity and a level of relationship between the respective independent variable and the dependent variable. The processors are further operable to, for each of the one or more independent variables, communicate, for display an indication of the level of sensitivity and an indication of the level of relationship between the respective independent variable and the dependent variable.

### TECHNICAL FIELD

This disclosure relates generally to the field of statistical modeling and more specifically to sensitivity analysis of an independent variable based on regression.

### BACKGROUND

In sensitivity analysis, the relationship of an independent variable to a dependent variable is typically determined based on a slope of an equation. Such a typical manner of determining this relationship, however, may be deficient.

### SUMMARY OF THE DISCLOSURE

According to one embodiment, a system includes a memory and one or more processors communicatively coupled to the memory. The memory is operable to store one or more calculation rules. The processors are operable to determine an equation that provides a relationship between a dependent variable of the equation and a plurality of independent variables of the equation. The processors are further operable to determine a predicted dependent variable based on the equation. The processors are further operable to, for one or more of the independent variables, perform a regression based on the predicted dependent variable and the one or more calculation rules. The processors are further operable to, for each of the one or more independent variables, determine, based on the regression, a level of sensitivity between the respective independent variable and the dependent variable. The processors are further operable to, for each of the one or more independent variables, determine, based on the regression, a level of relationship between the respective independent variable and the dependent variable. The processors are further operable to, for each of the one or more independent variables, communicate, for display: an indication of the level of sensitivity between the respective independent variable and the dependent variable; and an indication of the level of relationship between the respective independent variable and the dependent variable.

Certain embodiments of the disclosure may provide one or more technical advantages. For example, by performing sensitivity analysis of an independent variable based on regression, one or more problems associated with collinearity between two or more independent variables may be reduced. As such, the level of sensitivity between an independent variable and a dependent variable may be more accurately determined. As another example, by performing sensitivity analysis for an independent variable based on regression, a user may be able to understand how sensitive a dependent variable is to changes in an independent variable (e.g., a user may be able to understand how important the independent variable is to a dependent variable and/or how a change in value of an independent variable may impact a dependent variable in a statistical model).

Certain embodiments of the disclosure may include none, some, or all of the above technical advantages. One or more other technical advantages may be readily apparent to one skilled in the art from the figures, descriptions, and claims included herein.

### BRIEF DESCRIPTION OF THE DRAWINGS

For a more complete understanding of the present disclosure and its features and advantages, reference is now made to the following description, taken in conjunction with the accompanying drawings, in which:

FIG. 1 illustrates a system for performing sensitivity analysis according to one embodiment of the present disclosure; and

FIG. 2 illustrates an example display according to one embodiment of the present disclosure.

### DETAILED DESCRIPTION OF THE DRAWINGS

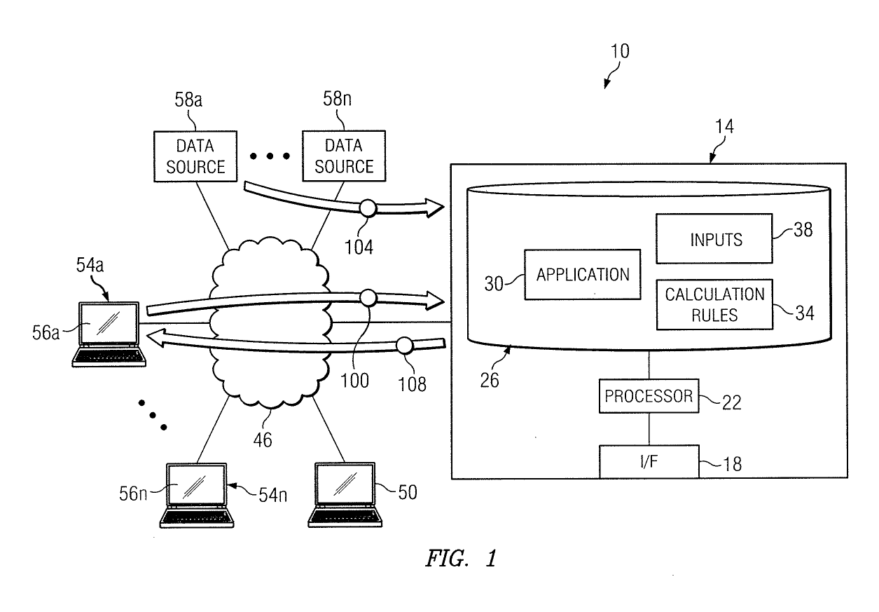

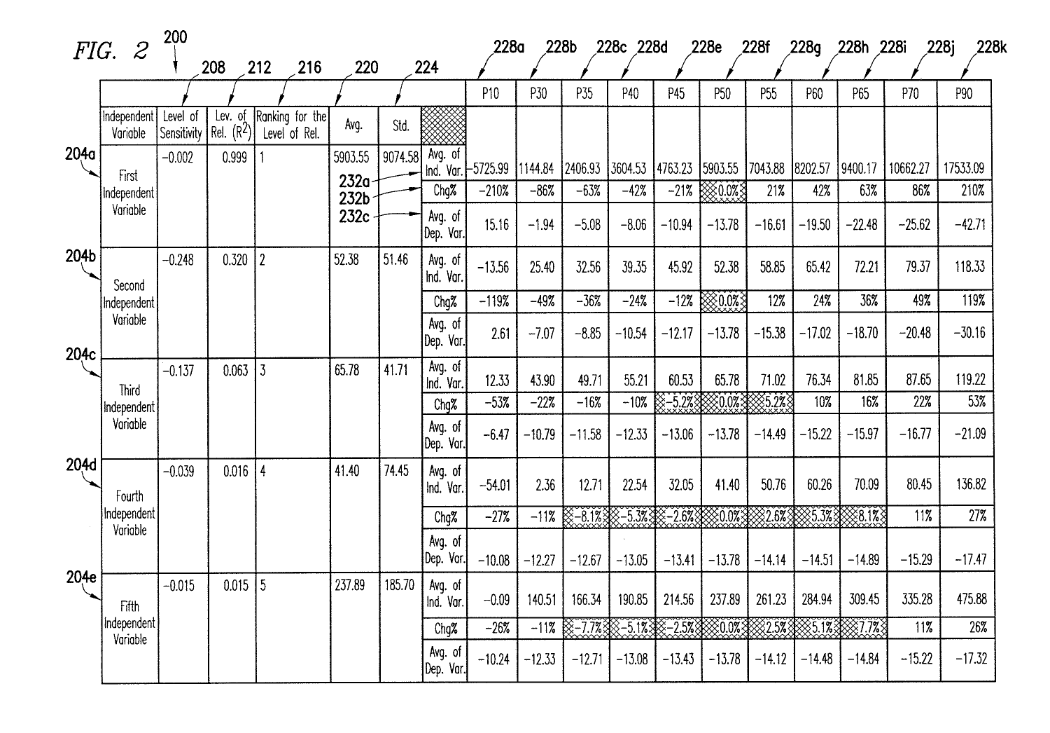

Embodiments of the present disclosure are best understood by referring to FIGS. 1 through 2 of the drawings, like numerals being used for like and corresponding parts of the various drawings.

FIG. 1 illustrates a system 10 for performing sensitivity analysis. For example, system 10 may perform a sensitivity analysis of an independent variable based on regression in order to determine a level of sensitivity between a particular independent variable and a dependent variable. As illustrated, system 10 includes a calculation device 14 that determines the level of sensitivity between an independent variable and a dependent variable. Calculation device 14 may further communicate for display an indication of the level of sensitivity between the independent variable and the dependent variable. Calculation device 14 may also perform stress testing on one or more independent variables. For example, for one or more independent variables, calculation device 14 may determine an average of the dependent variable at a first probability, and may further communicate for display an indication of the average of the dependent variable at the first probability.

By performing sensitivity analysis of an independent variable based on regression, calculation device 14 may allow a user to understand how sensitive a dependent variable is to changes in an independent variable (e.g., a user may be able to understand how important the independent variable is to a dependent variable and/or how a change in value of an independent variable may impact a dependent variable in a statistical model). Furthermore, because the sensitivity analysis of an independent variable is performed based on regression, one or more problems associated with collinearity between two or more independent variables may be reduced. As such, the level of sensitivity between an independent variable and a dependent variable may be more accurately determined.

Sensitivity analysis of an independent variable may refer to an analysis that may determine how different values of an independent variable may impact a particular dependent variable under a given set of assumptions. As an example, sensitivity analysis may be performed for a statistical model on, for example, the likelihood an individual is considered to be happy based on various variables, such as age, gender, income, education, marital status, and/or family size. In such an example, the dependent variable for the statistical model may be the likelihood an individual is considered to be happy (e.g., where happiness is scored between 0 and 10). The independent variables for such a statistical model may be the variables for age, gender, income, education, marital status, and/or family size. In such an example, the sensitivity analysis may determine how different values of one of the independent variables (e.g., such as an income value of $100,000 as opposed to an income value of $50,000) may impact the dependent variable (e.g., the likelihood an individual is considered to be happy).

Although sensitivity analysis has been described above as referring to a statistical model dealing with the likelihood an individual is considered to be happy, sensitivity analysis may be performed on any other type of statistical model. For example, sensitivity analysis may be performed on financial/economic statistical models (e.g., an amount of a home loan a person should be approved for, an amount of a credit line increase a person should be approved for, whether a person should be approved for a credit card, etc.), business statistical models (e.g., an amount of revenue by a business in a particular year, an amount of shareholder earnings for a particular year, the amount of products produced by a business in a particular year, etc.), environmental statistical models (e.g., the amount of global warming for a particular year, the amount of sea level increasing/decreasing in a particular year, an amount of smog increasing/decreasing in a particular year, etc.), any other statistical model, or any combination of the preceding.

Traditionally, in order to perform sensitivity analysis on a statistical model, an equation may be determined for the statistical model. Then, a level of sensitivity between one or more independent variables and a dependent variable (e.g., a level of sensitivity between a person's age and the likelihood the person is considered to be happy) may be determined by determining the slope of the independent variable in the equation. Unfortunately, such a typical method may be deficient because two or more independent variables may be collinear. As an example, as is discussed above, the likelihood a person is considered to be happy may be based on at least two independent variables: income and education. Unfortunately, the independent variables may be collinear because a person's income level may tend to increase as a person's education level increases. Such collinearity between independent variables may tend to affect the sensitivity analysis of each of the collinear independent variables.

However, such deficiencies of the typical sensitivity analysis methods may be addressed by system 10 of FIG. 1. As an example, calculation device 14 (of system 10) may perform a sensitivity analysis of an independent variable based on regression, which may overcome some of the deficiencies caused by collinearity between two or more independent variables. As such, calculation device 14 may perform a more accurate sensitivity analysis of an independent variable.

Calculation device 14 represents any components that perform sensitivity analysis of an independent variable based on regression. Calculation device 14 may include a network server, any remote server, a mainframe, a host computer, a workstation, a web space server, a personal computer, a file server, or any other device operable to perform sensitivity analysis of an independent variable based on regression. The functions of calculation device 14 may be performed by any combination of one or more servers or other components at one or more locations. In the embodiment where the module is a server, the server may be a private server, and the server may be a virtual or physical server. The server may include one or more servers at the same or remote locations. Also, calculation device 14 may include any component that functions as a server. In the illustrated embodiment, calculation device 14 includes a network interface 18, a processor 22, and a memory 26.

Network interface 18 represents any device operable to receive information from network 46, transmit information through network 46, perform processing of information, communicate to other devices, or any combination of the preceding. For example, network interface 18 may receive inputs 38 from user device 54 and/or information 104 from data sources 58. As another example, network interface 18 may communicate indications of the level of sensitivity between independent variables and the dependent variable for display on a user device 54. Network interface 18 represents any port or connection, real or virtual, including any suitable hardware and/or software, including protocol conversion and data processing capabilities, to communicate through a local area network (LAN), a metropolitan area network (MAN), a wide area network (WAN), or other communication system that allows calculation device 14 to exchange information with network 46, administration device 50, user devices 54, data sources 58, or other components of system 10.

Processor 22 communicatively couples to network interface 18 and memory 26, and controls the operation and administration of calculation device 14 by processing information received from network interface 18 and memory 26. Processor 22 includes any hardware and/or software that operates to control and process information. For example, processor 22 executes calculation device management application 30 to control the operation of calculation device 14. Processor 22 may be a programmable logic device, a microcontroller, a microprocessor, any processing device, or any combination of the preceding.

Memory 26 stores, either permanently or temporarily, data, operational software, or other information for processor 22. Memory 26 includes any one or a combination of volatile or non-volatile local or remote devices suitable for storing information. For example, memory 26 may include random access memory (RAM), read only memory (ROM), magnetic storage devices, optical storage devices, or any other information storage device or a combination of these devices. While illustrated as including particular modules, memory 26 may include any information for use in the operation of calculation device 14.

In the illustrated embodiment, memory 26 includes calculation device management application 30, calculation rules 34, and inputs 38. Calculation device management application 30 represents any suitable set of instructions, logic, or code embodied in a computer readable storage medium and operable to facilitate the operation of calculation device 14.

Calculation rules 34 represent any information that may be used to perform sensitivity analysis of an independent variable based on regression. Examples of calculation rules 34 are discussed below. Calculations rules 34 may be utilized by any suitable program and/or application executable by processor 22, such as SAS®, R, SPSS®, and/or STATA®.

Calculation rules 34 may be provided to calculation device 14 in any suitable manner. For example, a user (using the administration device 50 or the user device 54) may create and provide calculation rules 34 to calculation device 14 in order for them to be used to perform sensitivity analysis of an independent variable based on regression.

Inputs 38 represent any information that may be provided to calculation device 14. Examples of inputs 38 are discussed below. Inputs 38 may be provided to calculation device 14 in any suitable manner. For example, a user (using the administration device 50 or the user device 54) may provide inputs 38 to calculation device 14 in order for them to be used to perform sensitivity analysis of an independent variable based on regression.

Network 46 represents any network operable to facilitate communication between the components of system 10, such as calculation device 14, administration device 50, user devices 54, and data sources 58. Network 46 may include any interconnecting system capable of transmitting audio, video, signals, data, messages, or any combination of the preceding. Network 46 may include all or a portion of a public switched telephone network (PSTN), a public or private data network, a LAN, a MAN, a WAN, a local, regional, or global communication or computer network, such as the Internet, a wireline or wireless network, an enterprise intranet, or any other communication link, including combinations thereof, operable to facilitate communication between the components.

Administration device 50 represents any components that allow a user of the administration device 50 (such as an administrator) to control calculation device 14 and/or provide information to calculation device 14 (such as provide calculation rules 34 and/or inputs 38 to calculation device 14). Administration device 50 may include a personal computer, a workstation, a laptop, a wireless or cellular telephone, an electronic notebook, a personal digital assistant, or any other device (wireless, wireline, or otherwise) capable of receiving, processing, storing, and/or communicating information with other components of system 10 in order to allow a user to control calculation device 14 and/or provide information to calculation device 14. Administration device 50 may comprise a user interface, such as a display, a microphone, keypad, or other appropriate terminal equipment usable by a user.

User device 54 represents any components that may display information received from calculation device 14. User device 54 may include a personal computer, a workstation, a laptop, a wireless or cellular telephone, an electronic notebook, a personal digital assistant, or any other device (wireless, wireline, or otherwise) capable of receiving, processing, storing, and/or communicating information with other components of system 10 in order to display information received from calculation device 14. User device 54 may further allow a user to request information from calculation device 14 and/or provide information to calculation device 14. For example, in order to understand a level of sensitivity between an independent variable and a dependent variable, a user may provide a request 100 (and/or one or more inputs 38) to calculation device 14 in order for calculation device 14 to perform sensitivity analysis of an independent variable based on regression. User device 54 may comprise a user interface, such as a display, a microphone, keypad, or other appropriate terminal equipment usable by a user.

User device 54 may display a graphical user interface 56 in order to allow a user to view the information provided by calculation device 14. Graphical user interface 56 may include any graphical interface that allows the user to view information provided by calculation device 14, request information from calculation device 14, and/or provide information to calculation device 14. For example, graphical user interface 56 may allow a user to input one or more pieces of information (such as inputs 38) to transmit to calculation device 14. In particular embodiments, graphical user interface 58 may be accessible to a user through a web browser.

Although FIG. 1 illustrates system 10 as only including two user devices 54 (user device 54a and user device 54n), system 10 may include any suitable number of user devices 54. For example, system 10 may include less than two user devices 54 or more than two user devices 54.

Data source 58 may represent any source of information that may be used by calculation device 14. Data source 58 may include a device (such as a database, a personal computer, a workstation, a laptop, a wireless or cellular telephone, an electronic notebook, a personal digital assistant, or any other device capable of receiving, processing, storing, and/or communicating information), a person (such as a person who has knowledge of a statistical model (or of one or more independent and/or dependent variables) and who provides such knowledge for communication to a calculation device 14), one or more documents (such as a document that includes z values associated with stress testing), the Internet (which may include articles and other information about a statistical model (or about one or more independent and/or dependent variables)), any other suitable source of information, or any combination of the preceding. According to the illustrated embodiment, calculation device 14 may receive information 104 from data sources 58 in order to perform sensitivity analysis of an independent variable based on regression and/or perform one or more stress tests on an independent variable.

Although FIG. 1 illustrates calculation device 14, administration device 50, user devices 54, and data sources 58 as separate components, in particular embodiments, two or more of the calculation device 14, administration device 50, user devices 54, and data sources 58 may be the same component. For example, the calculation device 14, administration device 50, and user devices 54 may be the same device. As such, a user may view results of the sensitivity analysis and/or transmit inputs 38 at the same device that performs the sensitivity analysis. As another example, data sources 58 may be the same device as user devices 54. As such, calculation device 14 may receive information from the same device that displays results of the sensitivity analysis.

In an example embodiment of operations, in order for a user to understand the level of sensitivity between an independent variable and a dependent variable in a statistical model, a user may transmit a request 100 to calculation device 14. Request 100 may represent a request for any suitable determination and may include any suitable information to facilitate the determination. For example, request 100 may include a request for an indication of a level of sensitivity between an independent variable and a dependent variable, an indication of a level of relationship between an independent variable and a dependent variable, an indication of a ranking for the level of relationship between an independent variable and a dependent variable, results of stress testing of an independent variable, and/or any other suitable request. In one example, request 100 may refer to a user requesting that calculation device 14 perform one or more determinations and provide indications of such determinations.

In response to receiving a request 100, calculation device 14 may perform any type of determination for sensitivity analysis of an independent variable and/or stress testing on the independent variable. As an example, calculation device 14 may determine a level of sensitivity between an independent variable (e.g., income) and a dependent variable (e.g., a likelihood a person is considered to be happy) and/or perform stress testing on the independent variable. In order to do so, calculation device 14 may conduct various steps (discussed below). Additionally, in order to perform one or more of the following steps, calculation device 14 may further receive information 104, in particular embodiments. Information 104 may include any information received from data sources 58 and used by calculation device 14 to perform sensitivity analysis of an independent variable and/or perform stress testing on one or more independent variables. For example, information 104 may include data associated with a statistical model, one or more calculations rules 34 to be used in the sensitivity analysis, information used to perform stress testing of an independent variable, any other information, or any combination of the preceding. Furthermore, although information 104 is illustrated as being received from data sources 58, information 104 may be received from administration device 50 and/or user device 54, in particular embodiments.

Based at least on the information discussed above, calculation device 14 may perform one or more of the following steps. Calculation device 14 may perform each of the following steps, or may perform only a portion of the following steps, in particular embodiments. Furthermore, although the following steps are illustrated below as occurring in response to receiving request 100, in particular embodiments, one or more of the following steps may occur prior to receiving request 100.

First, calculation device 14 may determine an equation for performing sensitivity analysis. The equation may be any equation that provides a relationship between a dependent variable of the equation and one or more independent variables of the equation. As an example, in order to perform sensitivity analysis for the likelihood a person is considered to be happy based on their age, gender, income, education, marital status, and family size, an equation may be determined that provides a relationship between the dependent variable (e.g., the likelihood a person is considered to be happy) and each of the independent variables (e.g., age, gender, income, education, marital status, and family size). The equation may be any suitable equation. For example, the equation may be:

Y=β₀+β₁*X₁+β₂*X₂ . . . βₙ*Xₙ
Wherein Y is the dependent variable
Wherein X₁ is the first independent variable
Wherein X₂ is the second independent variable
Wherein β₀ is the initial starting value (e.g., the intercept)
Wherein β₁ is the level of sensitivity between the first independent variable and the dependent variable.
Wherein β₂ is the level of sensitivity between the second independent variable and the dependent variable.

The equation may be determined in any suitable manner. For example, calculation device 14 may receive the equation from a user (using the administration device 50 or the user device 54) as input 38 and/or request 100, and/or may receive the equation from data sources 58 as information 104. In such an example, calculation device 14 may determine the equation by accessing inputs 38, request 100, and/or information 104. As another example, calculation device 14 may calculate the equation. In such an example, data associated with a statistical model (e.g., from inputs 38, request 100, and/or information 104) may be accessed by calculation device 14 in order to calculate the equation. The data may include any data associated with the statistical model, data associated with one or more dependent variables, data associated with one or more independent variables, any other information for calculating the equation, or any combination of the preceding. As an example, the data may include data associated with 10 people who conducted a survey regarding happiness. Each of the people may have provided an indication of their happiness (e.g., 1 through 10), and may have further provided an indication of their age, gender, income, education, marital status, and/or family size. This data may be accessed by calculation device 14 (e.g., from inputs 38, request 100, and/or information 104) in order for calculation device 14 to calculate the equation. The calculation of the equation may be performed in any suitable manner. For example, the data may be graphed and linear regression of the graph may be performed in order to calculate the equation. Furthermore, calculation device 14 may calculate the equation using one or more regression methods (such as logistic regression, linear regression, etc.) and/or machine learning methods (such as decision tree, neuronetwork, etc.).

Second, calculation device 14 may determine a predicted dependent variable based on the equation. The predicted variable may refer to a predicted value of the dependent variable that may be utilized in order to perform a regression. The predicted dependent variable may be determined in any suitable manner. As an example, the dependent variable may be calculated based on the data associated with the statistical model. For example, as is discussed above, 10 people may have answered a survey with regard to their happiness. In such an example, the predicted dependent variable may be the average dependent variable selected by the 10 people. For example, if each of the 10 individuals selected a different number in-between 1 and 10, the average of those selections may be 5.5. As such, the predicted dependent variable may be determined to be 5.5. As another example, the predicted dependent variable may be calculated based on the equation. In such an example, the predicted dependent variable may be calculated as the sum of independent variables multiplied by the coefficients. As a further example, the predicted dependent variable may be determined based on an input from a user or data source 58 (e.g., from inputs 38, request 100, and/or information 104).

Third, calculation device 14 may perform a regression based on the predicted dependent variable. The regression may be performed for one or more of the independent variables. As an example, if there are 6 independent variables, the regression may be performed for all 6 independent variables, only 1 of the independent variables, or any other number of the independent variables.

The regression may be performed in any suitable manner. As a first example, the regression based on the predicted dependent variable may be performed according to the following calculation rules 34:

Y=α′+β′X₁+e
Wherein Y the predicted dependent variable
Wherein α′ is the initial starting value (e.g., the intercept)
Wherein β (e.g., the level of sensitivity between the first independent variable and the dependent variable) is determined based on a simple regression of Y=α+β*Xᵢ
Wherein e′ is an error rate

$${R}^{2} ≡ 1 - \frac{{SS}_{res}}{{SS}_{tot}} .$$

Wherein R² (or the coefficient of determination) is the level of relationship between the independent variable and the dependent variable
Wherein SSᵣₑₛ is the sum of squares of residuals, which may be calculated based on a simple regression of Y=Xᵢ
Wherein SSₜₒₜ is the total sum of squares, which also may be calculated based on a simple regression of Y=Xᵢ

In such an example, the regression may be performed for each of the independent variables separately. As another example, the regression may be performed for each of the independent variables at the same time. In such an example, calculation device 14 may perform linear regression based on the predicted dependent variable according to the following calculation rules 34:

$$Y = α + {\sum }_{1}^{n} {β}_{i } {X}_{i} + e$$

$${X}_{n} = {α}_{n} + {\sum }_{1}^{n - 1} {β}_{i} {X}_{i} + {e}_{n}$$

$$…$$

$${X}_{k} = {α}_{k} + {\sum }_{1}^{k - 1} {β}_{i} {X}_{i} + {e}_{k}$$

$$…$$

$${X}_{2} = {α}_{1} + {β}_{1} {X}_{1} + {e}_{1}$$

Wherein Y is the predicted dependent variable
Wherein α is the initial starting value (e.g., the intercept)
Wherein β (e.g., the level of sensitivity between the first independent variable and the dependent variable) is determined based on a simple regression of Y=α+β*Xᵢ
Wherein e′ is an error rate

$${R}^{2} ≡ 1 - \frac{{SS}_{res}}{{SS}_{tot}} .$$

Wherein R² (or the coefficient of determination) is the level of relationship between the independent variable and the dependent variable
Wherein SSᵣₑₛ is the sum of squares of residuals, which may be calculated based on a simple regression of Y=Xᵢ
Wherein SSₜₒₜ is the total sum of squares, which also may be calculated based on a simple regression of Y=Xᵢ

Fourth, calculation device 14 may determine the level of sensitivity between an independent variable and a dependent variable. The level of sensitivity between the independent variable and the dependent variable may refer to the impact a change in value of the independent variable has on the dependent variable. For example, if the level of sensitivity between the independent variable and the dependent variable is 1.8, the dependent variable may increase by 1.8 units for every unit of increase of the independent variable. On the other hand, if the level of sensitivity between the independent variable and the dependent variable is 0.39, the dependent variable may increase by 0.39 units for every unit of increase of the independent variable.

The level of sensitivity between the independent variable and the dependent variable may be determined based on the regression performed in step 3 above. For example, the level of sensitivity between the independent variable and the dependent variable may be determined to be β from the above regression. In such an example, the level of sensitivity between the first independent variable and the dependent variable may be β₁, the level of sensitivity between the second independent variable and the dependent variable may be β₂, and the level of sensitivity between the n^{th} independent variable and the dependent variable may be βₙ. The level of sensitivity between the independent variable and the dependent variable may also (or alternatively) be determined based on an average of a group of decision trees. Furthermore, the level of sensitivity between the independent variable and the dependent variable may be determined for one or more of the independent variables. As an example, if there are 6 independent variables, the level of sensitivity between the independent variable and the dependent variable may be determined for all 6 independent variables, only 1 of the independent variables, or any other number of the independent variables.

Fifth, calculation device 14 may determine a level of relationship between the independent variable and the dependent variable. The level of relationship between the independent variable and the dependent variable may refer to how closely related the independent variable is to the dependent variable. As an example, if the level of relationship between the independent variable and the dependent variable is high, a change in value of the independent variable may have a high impact on the dependent variable. On the other hand, if the level of relationship between the independent variable and the dependent variable is low, a change in value of the independent variable may have a low impact on the dependent variable. The level of relationship between the independent variable and the dependent variable may be determined based on the regression performed in step 3 above. For example, the level of relationship between the independent variable and the dependent variable may be determined to be R² from the above regression. The level of relationship between the independent variable and the dependent variable may also (or alternatively) be determined based on an average of a group of decision trees.

Sixth, calculation device 14 may determine a ranking for the relationship between the independent variable and the dependent variable. The ranking for the level of relationship between the independent variable and the dependent variable may refer to a ranking of the independent variable's relationship to the dependent variable compared to the other independent variables' relationships with the dependent variable. As an example, if the first independent variable has the highest level of relationship to the dependent variable of all of the other independent variables, the first independent variable may have the highest ranking. In such an example, the first independent variable may be ranked as number 1 (of, for example, 6 independent variables). On the other hand, if the first independent variable has the lowest level of relationship to the dependent variable of all of the other independent variables, the first independent variable may have the lowest ranking. In such an example, the first independent variable may be ranked as number 6 (of, for example, 6 independent variables).

In addition to determining the level of sensitivity between an independent variable and the dependent variable, determining the level of relationship between an independent variable and the dependent variable, and determining a ranking for the level of relationship between an independent variable and the dependent variable, calculation device 14 may further perform stress testing on one or more of the independent variables. Stress testing may refer to determining the change to a dependent variable associated with a statistic model based on how an independent variable changes according to one or more probabilities. For example, stress testing may determine how a dependent variable changes when the first independent variable has a value at a particular probability (e.g., such as a value that has a 10% chance of occurring (P 10)). Calculation device 14 may perform stress testing on an independent variable according to one or more of the following steps 7 through 9. Furthermore, calculation device 14 may perform stress testing for one or more of the independent variables. As an example, if there are 6 independent variables, the stress testing may be performed for all 6 independent variables, only 1 of the independent variables, or any other number of the independent variables.

Seventh, calculation device 14 may determine an average of the dependent variable at a first probability. The average of the dependent variable at a first probability may refer to an average (or mean) value of the dependent variable when the value of the independent variable changes from an average probability (e.g., a value with a 50% chance of occurring) to a first probability (e.g., a value with a 10% chance of occurring (P10), a value with a 20% chance of occurring (P20), a value with a 30% chance of occurring (P30), or a value with any other percentage of chance of occurring). The average of the dependent variable may be determined in any suitable manner. As an example, the average of the dependent variable may be determined according to the following calculation rule 34:

ADₙ=AD₅₀+Sₓ₍ᵢ₎*Zₙ*Std
Wherein ADₙ is the average dependent variable at the n^{th} probability
Wherein AD₅₀ is the average dependent variable at the 50% probability
Wherein Sₓ₍ᵢ₎ is the level of sensitivity between the independent variable Xᵢ and the dependent variable
Wherein Zₙ is the z score associated with the n^{th} probability
Wherein Std is the standard deviation of the independent variable Xᵢ

A z score (seen above with regard to the calculation rule) refers to a statistical measurement of a score's relationship to the mean in a group of scores. Each probability utilized in the stress testing of an independent variable may have a different z score. For example, P10 may have a different z score than P20. The z score for a particular probability may be determined from input 38, request 100, and/or information 108. As an example, when calculation device 14 is performing a stress test for the 10% probability (e.g., P10), calculation device 14 may query data sources 58 for the z score associated with P10. In response to such a query, data sources 58 may provide the z score for P10.

Eighth, calculation device 14 may determine an average of the independent variable at the first probability. The average of the independent variable at the first probability may refer to an average (or mean) value that the independent variable may have at the first probability. For example, at the 10% probability, the average value of the independent variable may be an average value that has a 10% chance of occurring. The average of the independent variable at the first probability may be determined in any suitable manner. As an example, the average of the independent variable at the first probability may be determined in accordance with the following calculation rule 34:

Xᵢ₍ₙ₎=Xᵢ₍₅₀₎+Zₙ*Std
Wherein Xᵢ₍ₙ₎ is the average of independent variable Xᵢ at the n^{th} probability
Wherein Xᵢ₍₅₀₎ is the average of independent variable Xᵢ at the 50% probability
Wherein Zₙ is the z score associated with the n^{th} probability
Wherein Std is the standard deviation of the independent variable Xᵢ

Ninth, calculation device 14 may determine the percentage of change of the dependent variable from the 50% probability to the first probability. The percentage of change of the dependent variable from the 50% probability to the first probability may refer to an amount of change (in percentage) of the average value of the dependent variable between 50% probability and the first variable (e.g., P10). For example, if the dependent variable has an average value of −13.78 at the 50% probability and an average value of 15.16 at the 10% probability, the percentage of change of the dependent variable may be −210%.

Tenth, based on one or more of the determinations made by calculation device 14, calculation device 14 may communicate results 108 of one or more of the determinations for display to a user. Results 108 may include any suitable information to be displayed in any suitable format. As an example, results 108 may include an indication of a level of sensitivity between an independent variable and a dependent variable, an indication of a level of relationship between an independent variable and a dependent variable, an indication of the ranking for the level of relationship between an independent variable and the dependent variable, an average of a dependent variable at a n^{th} probability, an average of the independent variable at the n^{th} probability, and/or the percentage of change of the dependent variable between the n^{th} probability and the 50% probability. Additionally, results 108 may include any of the other determinations made by calculation device 14. Furthermore, user device 54 may display results 108 on graphical user interface 56. As such, a user of user device 54 may be able to understand the impact a change to an independent variable may have on a dependent variable in a statistical model. Example results 108 communicated by calculation device 14 and displayed to the user are discussed below with regard to FIG. 2.

Modifications, additions, or omissions may be made to system 10 without departing from the scope of the disclosure. For example, the determinations performed by calculation device 14 may be performed without receiving a request from a user. As such, if a user does later request to view a particular level of sensitivity between an independent variable and a dependent variable, for example, the level of sensitivity may have already been determined, and may be communicated without any further determinations. Additionally, system 10 may include any number of calculation devices 14, networks 46, administration devices 50, user devices 54, and/or data sources 58. Furthermore, any suitable logic may perform the functions of system 10 and the components within system 10.

FIG. 2 illustrates an example display 200 according to one embodiment of the present disclosure. Display 200 includes one or more of the determinations performed by calculation device 14 of FIG. 1 and/or one or more of results 108 transmitted by calculation device 14 of FIG. 1. Display 200 may be displayed to a user using a user device, such as user device 54a of FIG. 1. Display 200 may be displayed to a user in response to the user providing a request for information included in display 200, in particular embodiments.

As illustrated, display 200 includes independent variable entries 204a-e. Independent variable entry 204 provides a display of indications associated with an independent variable. For example, independent variable entry 204a provides a display of indications associated with the first independent variable. Furthermore, independent variable entries 204b-e provide displays of the indications associated with each of the second independent variable, third independent variable, fourth independent variable, and fifth independent variable.

Display 200 may further include various columns that include indications associated with each of the independent variables. For example, display 200 includes level of sensitivity column 208, level of relationship column 212, and ranking for the level of relationship column 216. The level of sensitivity column 208 may include the level of sensitivity between an independent variable and the dependent variable. For example, as illustrated, the first independent variable has a level of sensitivity of −0.002. The level of relationship column 212 may include an indication of a level of relationship between an independent variable and a dependent variable. For example, the first independent variable has a level of relationship of 0.999. The ranking for the level of relationship column 216 may include an indication of the ranking for the level of relationship between the independent variable and the dependent variable. For example, first independent variable has a ranking of 1 (of, for example, 5 independent variables).

Display 200 may further include an average of independent variable column 220 and a standard deviation of independent variable 224. The average of independent variable column 220 may include an indication of the average value of the independent variable at the 50% probability. For example, the first independent variable has an average of the independent variable at the 50% probability of 5,903.55. The standard deviation of independent variable column 224 may include an indication of the standard deviation of the independent variable. For example, first independent variable includes a standard deviation of 9,074.58.

Display 200 may further include probability columns 228. For example, as illustrated, display 200 includes a probability column 228a for P10, a probability column 228b for P30, a probability column 228c for P35, a probability column 228d for P40, a probability column 228e for P45, a probability column 228f for P50, a probability column 228g for P55, a probability column 228h for P60, a probability column 228i for P65, a probability column 228j for P70, and a probability column 228k for P90. Although display 200 is illustrated as including particular probability columns, any other probability column may be included in display 200.

Probability columns 228 may include indications for each independent variable. As an example, probability column 228a may include an indication of the average of independent variable 232a, an indication of the percentage of change of the dependent variable 232b, and an indication of the average of the dependent variable 232c. In such an example, at the 10% probability (e.g., P10), the first independent variable may have an average of independent variable of −5,725.99, a percentage of change of the dependent variable of −210% and an average of the dependent variable of 15.16.

Probability columns 228 may further include one or more color indications associated with independent variables. As an example, as is seen in display 200, one or more of the indications of the percentage of change of the dependent variable (e.g., row 232b of the first independent variable) may be highlighted in a particular color when the percentage of change is less than 10%. Such a color change may assist the user in determining which independent variable may cause a percentage of change of the dependent variable of more than 10% across one or more probabilities of the independent variable.

Although display 200 has been described above as only including particular information, any other suitable information may be included in display 200. For example, display 200 may include more, less, or different probability columns 228. Furthermore, the information displayed in display 200 may be displayed in any other suitable arrangement.

Although the present disclosure has been described with several embodiments, a myriad of changes, variations, alterations, transformations, and modifications may be suggested to one skilled in the art, and it is intended that the present disclosure encompass such changes, variations, alterations, transformations, and modifications as fall within the scope of the appended claims.

What is claimed is:

1. A system, comprising:
a memory operable to store one or more calculation rules;
one or more processors communicatively coupled to the memory and operable to:
determine an equation that provides a relationship between a dependent variable of the equation and a plurality of independent variables of the equation;
determine a predicted dependent variable based on the equation;
for one or more of the independent variables, perform a regression based on the predicted dependent variable and the one or more calculation rules;
for each of the one or more independent variables:
determine, based on the regression, a level of sensitivity between the respective independent variable and the dependent variable;
determine, based on the regression, a level of relationship between the respective independent variable and the dependent variable; and
communicate, for display:
an indication of the level of sensitivity between the respective independent variable and the dependent variable; and
an indication of the level of relationship between the respective independent variable and the dependent variable.

2. The system of claim 1, wherein the one or more processors are further operable to:
for each of the one or more independent variables:
determine a ranking for the level of relationship between the respective independent variable and the dependent variable; and
communicate, for display, an indication of the ranking for the level of relationship between the respective independent variable and the dependent variable.

3. The system of claim 1, wherein the one or more processors are further operable to perform stress testing on each of the one or more independent variables.

4. The system of claim 1, wherein the one or more processors are further operable to:
for each of the one or more independent variables:
determine an average of the dependent variable at a first probability;
determine an average of the respective independent variable at the first probability;
determine an average of the dependent variable at a second probability;
determine an average of the respective independent variable at the second probability; and
communicate for display:
an indication of the average of the dependent variable at the first probability;
an indication of the average of the respective independent variable at the first probability;
an indication of the average of the dependent variable at the second probability; and
an indication of the average of the respective independent variable at the second probability.

5. The system of claim 4, wherein:
the average of the dependent variable at the first probability is determined based on:
an average of the dependent variable at a fifty percent probability;
the level of sensitivity between the respective independent variable and the dependent variable;
a z score associated with the first probability; and
a standard deviation of the respective independent variable; and
the average of the respective independent variable at the first probability is determined based on:
an average of the independent variable at the fifty percent probability;
the z score associated with the first probability; and
the standard deviation of the respective independent variable.

6. The system of claim 1, wherein the one or more calculation rules comprise:
Y=α′+β′X₁+e′.

7. The system of claim 1, wherein the one or more calculation rules comprise:
$$Y = α + {\sum }_{1}^{n} {β}_{i } {X}_{i} + e$$
$${X}_{n} = {α}_{n} + {\sum }_{1}^{n - 1} {β}_{i} {X}_{i} + {e}_{n}$$
$$…$$
$${X}_{k} = {α}_{k} + {\sum }_{1}^{k - 1} {β}_{i} {X}_{i} + {e}_{k}$$
$$…$$
$${X}_{2} = {α}_{1} + {β}_{1} {X}_{1} + {e}_{1} .$$

8. A non-transitory computer readable medium comprising logic, the logic, when executed by a processor, operable to:
determine an equation that provides a relationship between a dependent variable of the equation and a plurality of independent variables of the equation;
determine a predicted dependent variable based on the equation;
for one or more of the independent variables, perform a regression based on the predicted dependent variable and one or more calculation rules;
for each of the one or more independent variables:
determine, based on the regression, a level of sensitivity between the respective independent variable and the dependent variable;
determine, based on the regression, a level of relationship between the respective independent variable and the dependent variable; and
communicate, for display:
an indication of the level of sensitivity between the respective independent variable and the dependent variable; and
an indication of the level of relationship between the respective independent variable and the dependent variable.

9. The computer readable medium of claim 8, wherein the logic, when executed by the processor, is further operable to:
for each of the one or more independent variables:
determine a ranking for the level of relationship between the respective independent variable and the dependent variable; and
communicate, for display, an indication of the ranking for the level of relationship between the respective independent variable and the dependent variable.

10. The computer readable medium of claim 8, wherein the logic, when executed by the processor, is further operable to perform stress testing on each of the one or more independent variables.

11. The computer readable medium of claim 8, wherein the logic, when executed by the processor, is further operable to:
for each of the one or more independent variables:
determine an average of the dependent variable at a first probability;
determine an average of the respective independent variable at the first probability;
determine an average of the dependent variable at a second probability;
determine an average of the respective independent variable at the second probability; and
communicate for display:
an indication of the average of the dependent variable at the first probability;
an indication of the average of the respective independent variable at the first probability;
an indication of the average of the dependent variable at the second probability; and
an indication of the average of the respective independent variable at the second probability.

12. The computer readable medium of claim 11, wherein:
the average of the dependent variable at the first probability is determined based on:
an average of the dependent variable at a fifty percent probability;
the level of sensitivity between the respective independent variable and the dependent variable;
a z score associated with the first probability; and
a standard deviation of the respective independent variable; and
the average of the respective independent variable at the first probability is determined based on:
an average of the independent variable at the fifty percent probability;
the z score associated with the first probability; and
the standard deviation of the respective independent variable.

13. The computer readable medium of claim 8, wherein the one or more calculation rules comprise:
Y=α′+β′X₁+e′.

14. A method, comprising:
determining, by one or more processors, an equation that provides a relationship between a dependent variable of the equation and a plurality of independent variables of the equation;
determining, by the one or more processors, a predicted dependent variable based on the equation;
for one or more of the independent variables, performing, by the one or more processors, a regression based on the predicted dependent variable and one or more calculation rules:
for each of the one or more independent variables:
determining, by the one or more processors and based on the regression, a level of sensitivity between the respective independent variable and the dependent variable;
determining, by the one or more processors and based on the regression, a level of relationship between the respective independent variable and the dependent variable; and
communicating, by the one or more processors, for display:
an indication of the level of sensitivity between the respective independent variable and the dependent variable; and
an indication of the level of relationship between the respective independent variable and the dependent variable.

15. The method of claim 14, further comprising:
for each of the one or more independent variables:
determining, by the one or more processors, a ranking for the level of relationship between the respective independent variable and the dependent variable; and
communicating, by the one or more processors, for display, an indication of the ranking for the level of relationship between the respective independent variable and the dependent variable.

16. The method of claim 14, further comprising performing, by the one or more processors, stress testing on each of the one or more independent variables.

17. The method of claim 14, further comprising:
for each of the one or more independent variables:
determining, by the one or more processors, an average of the dependent variable at a first probability;
determining, by the one or more processors, an average of the respective independent variable at the first probability;
determining, by the one or more processors, an average of the dependent variable at a second probability;
determining, by the one or more processors, an average of the respective independent variable at the second probability; and
communicating, by the one or more processors, for display:
an indication of the average of the dependent variable at the first probability;
an indication of the average of the respective independent variable at the first probability;
an indication of the average of the dependent variable at the second probability; and
an indication of the average of the respective independent variable at the second probability.

18. The method of claim 17, wherein:
the average of the dependent variable at the first probability is determined based on:
an average of the dependent variable at a fifty percent probability;
the level of sensitivity between the respective independent variable and the dependent variable;
a z score associated with the first probability; and
a standard deviation of the respective independent variable; and
the average of the respective independent variable at the first probability is determined based on:
an average of the independent variable at the fifty percent probability;
the z score associated with the first probability; and
the standard deviation of the respective independent variable.

19. The method of claim 14, wherein the one or more calculation rules comprise:
Y=α′+β′X₁+e′.

20. The method of claim 14, wherein the one or more calculation rules comprise:
$$Y = α + {\sum }_{1}^{n} {β}_{i } {X}_{i} + e$$
$${X}_{n} = {α}_{n} + {\sum }_{1}^{n - 1} {β}_{i} {X}_{i} + {e}_{n}$$
$$…$$
$${X}_{k} = {α}_{k} + {\sum }_{1}^{k - 1} {β}_{i} {X}_{i} + {e}_{k}$$
$$…$$
$${X}_{2} = {α}_{1} + {β}_{1} {X}_{1} + {e}_{1} .$$
